(19) United States
(12) Patent Application Publication
(10) Pub. No.: US 2023/0152176 A1
(43) Pub. Date: May 18, 2023

(54) Pressure Gauge for Air Pump

(71) Applicant: Scott Wu, Taichung City (TW)

(72) Inventor: Scott Wu, Taichung City (TW)

(21) Appl. No.: 17/524,805

(22) Filed: Nov. 12, 2021

(51) Int. Cl. G01L 19/10; G01L 19/14

(52) U.S. Cl. CPC G01L 19/10; G01L 19/143

(57) ABSTRACT

A pressure gauge adapted to be mounted in a containing recess of an air pump includes a housing arranged in the containing recess, a driving member movably arranged in the housing, a biasing member biasing the driving member toward the housing, a driven member configured to be driven to rotate by the driving member, a pointer needle connected with the driven member, a scale plate disposed between the driven member and the pointer needle, and a guiding member arranged between the housing and the driving member. The guiding member is configured to contact at least one of the housing and the driving member to remain the driving member moving relative to the housing in a straight direction.

### BACKGROUND

The present invention relates to a pressure gauge and, more particular, to a pointer pressure gauge for a compact air pump.

Conventional portable air pumps usually have a compact appearance in order to be convenient to carry. Thus, the portable air pump will inevitably lose the convenience of pumping operations in order to have a compact appearance. For example, the portable pump usually does not provide a pressure gauge for measuring and displaying the pressure value. In addition, if the portable pump provides a pressure gauge, the elements of the pressure gauge must have a small size, and how to make the pressure gauge with smaller elements can accurately measure the pressure value has become a problem that needs to be improved.

### SUMMARY

An objective of the present invention is to provide a pressure gauge, which includes a housing arranged in a containing recess of an air pump, a driving member movably arranged in the housing, a biasing member configured to bias the driving member toward the housing, a driven member configured to be driven to rotate by the driving member, a pointer needle connected with the driven member, a scale plate disposed between the driven member and the pointer needle, and a guiding member arranged between the housing and the driving member and configured to contact at least one of the housing and the driving member to remain the driving member moving relative to the housing in a straight direction.

In an embodiment, the housing has a sliding hole and an air inlet hole communicating with the sliding hole. The air inlet hole permits the compressed air from the air pump to enter the sliding hole and to propel the driving member. The driving member has a sliding portion movably arranged in the sliding hole, and a driving portion formed on an outer periphery of the sliding portion. The sliding portion is configured to be propelled by the compressed air entering the sliding hole from the air inlet hole to move relative to the sliding hole along a reference axis. The driving portion connects with the driven member to drive the driven member to rotate.

In an embodiment, the housing further has a notch formed an outer periphery thereof and communicating with the sliding hole. The driving portion has an extending section extended from the outer periphery of the sliding portion, and a gear rack formed from the extending section and extended along the straight direction parallel to the reference axis. The extending section extends through out of the sliding hole via the notch. The gear rack is perpendicular to the extending section and separated from the outer periphery of the sliding portion by a gap formed between the sliding portion and the gear rack. The driven member has an annular teeth portion formed around an outer periphery thereof and meshed with the gear rack. The gear rack corresponds the sliding portion moving relative to the sliding hole to move along the straight direction parallel to the reference axis to drive the driven member to rotate.

In an embodiment, the guiding member is integrally formed at an end of the gear rack opposite to the extending section and constantly abuts against the outer periphery of the housing.

In an embodiment, the guiding member has an arc face abutting against the outer periphery of the housing.

In another embodiment, the guiding member is integrally formed on the outer periphery of the housing and constantly abuts against the gear rack.

In another embodiment, the guiding member has an arc face abutting against the gear rack.

In an embodiment, the biasing member has a first end elastically abutting against the containing recess, and a second end elastically abutting against the driving member.

The present invention will become clearer in light of the following detailed description of illustrative embodiments of this invention described in connection with the drawings.

### BRIEF DESCRIPTION OF THE DRAWINGS

FIG. 1 is an exploded, perspective view of a pressure gauge of a first embodiment according to the present invention.

FIGS. 2 and 3 are cross sectional views of the pressure gauge of the first embodiment according to the present invention.

FIG. 4 is a cross sectional views of a pressure gauge of the second embodiment according to the present invention.

### DETAILED DESCRIPTION

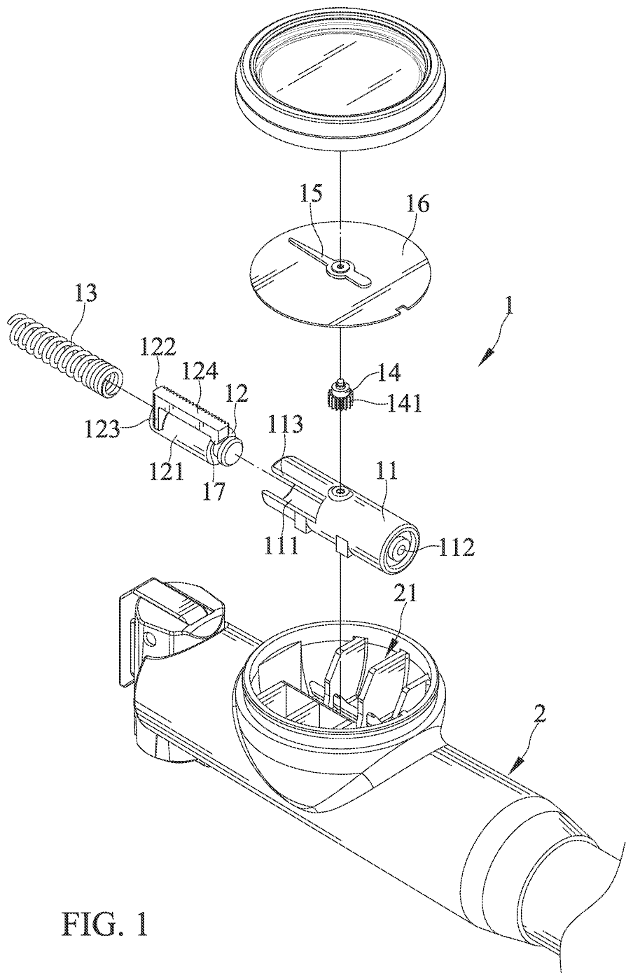

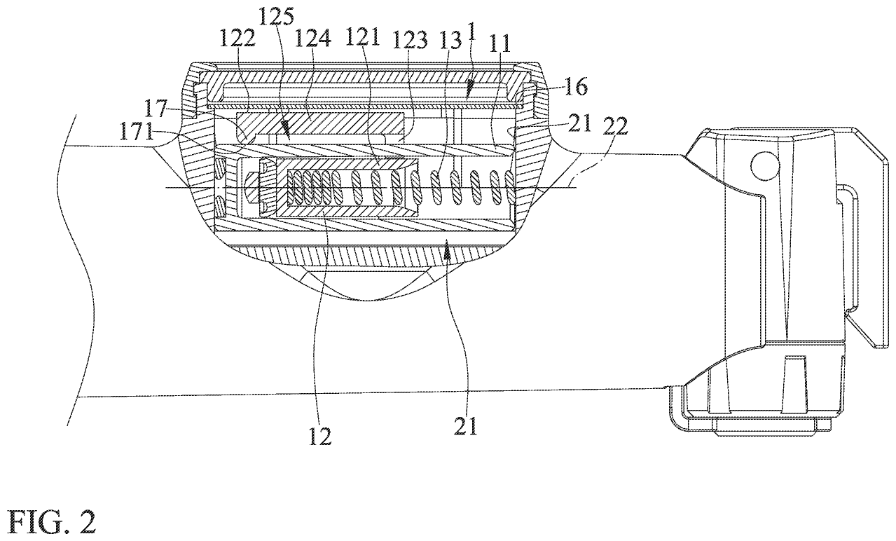

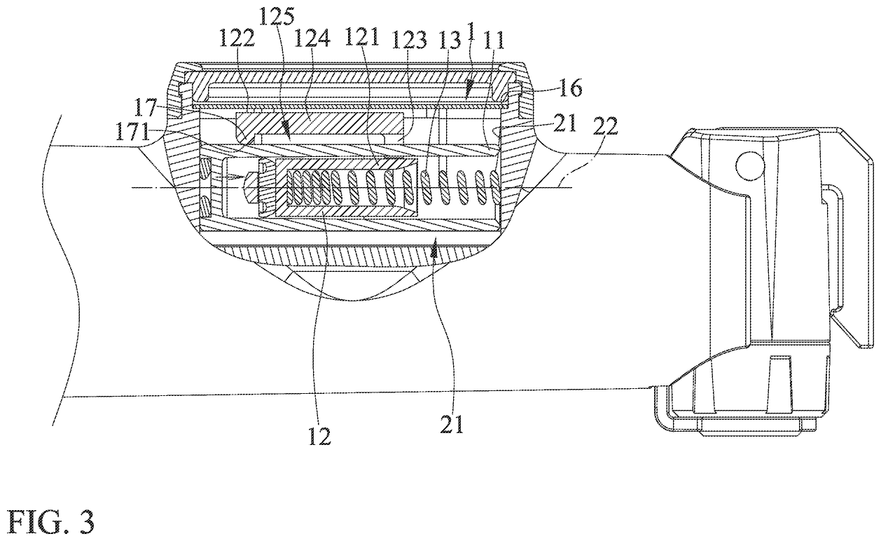

FIGS. 1-3 show a pressure gauge 1 for an air pump 2 of a first embodiment according to the present invention. The pressure gauge 1 is adapted to be mounted in a containing recess 21 of an air pump 2. The air pump 2 is mentioned in this embodiment may be a portable air pump, and the containing recess 21 is formed on a head portion of the air pump 2. The pressure gauge 1 includes a housing 11 arranged in the containing recess 21 and permitting the compressed air from the air pump 2 to enter therein, a driving member 12 movably arranged in the housing 11 and configured to be propelled by the compressed air from the air pump 2, a biasing member 13 configured to bias the driving member 12 toward the housing 11, a driven member 14 configured to be driven to rotate by the driving member 12, a pointer needle 15 connected with the driven member 14, a scale plate 16 disposed between the driven member 14 and the pointer needle 15, and a guiding member 17 arranged between the housing 11 and the driving member 12. The guiding member 17 is configured to contact at least one of the housing 11 and the driving member 12 to remain the driving member 12 moving relative to the housing 11 in a straight direction to accurately measure and display the pressure value.

The biasing member 13 has a first end elastically abutting against the containing recess 21, and a second end elastically abutting against the driving member 12. Thus, the biasing member 13 may be a spring.

Further, the housing 11 has a sliding hole 111 and an air inlet hole 112 communicating with the sliding hole 111. The air inlet hole 112 permits the compressed air from the air pump 2 to enter the sliding hole 111 and to propel the driving member 12. The driving member 12 has a sliding portion 121 movably arranged in the sliding hole 111, and a driving portion 122 formed on an outer periphery of the sliding portion 121. The sliding portion 121 is configured to be propelled by the compressed air entering the sliding hole 111 from the air inlet hole 112 to move relative to the sliding hole 111 along a reference axis 22. The driving portion 122 connects with the driven member 14 to drive the driven member 14 to rotate.

Furthermore, the housing 11 has a notch 113 formed an outer periphery thereof and communicating with the sliding hole 111. The driving portion 122 has an extending section 123 extended from the outer periphery of the sliding portion 121, and a gear rack 124 formed from the extending section 123 and extended along the straight direction parallel to the reference axis 22. The extending section 123 extends through out of the sliding hole 111 via the notch 113. The gear rack 124 is perpendicular to the extending section 123 and separated from the outer periphery of the sliding portion 121 by a gap 125 formed between the sliding portion 121 and the gear rack 124. The driven member 14 has an annular teeth portion 141 formed around an outer periphery thereof and meshed with the gear rack 124. The gear rack 124 corresponds the sliding portion 121 moving relative to the sliding hole 111 to move along the straight direction parallel to the reference axis 22 to drive the driven member 14 to rotate, so that the driven member 14 actuates the pointer needle 15 to indicate the pressure value on the scale plate 16.

In the embodiment, the guiding member 17 is integrally formed at an end of the gear rack 124 opposite to the extending section 123 and constantly abuts against the outer periphery of the housing 11. Thus, the driving member 12 and the guiding member 17 may be integrally formed by plastic injection, and the guiding member 17 abuts against the outer periphery of the housing 11 to prevent the inaccurate pressure value since the gear rack 124 is deviated from the extending section 123 due to excessive length.

Moreover, the guiding member 17 has an arc face 171 abutting against the outer periphery of the housing 11 to reduce the friction between the guiding member 17 and the outer periphery of the housing 11.

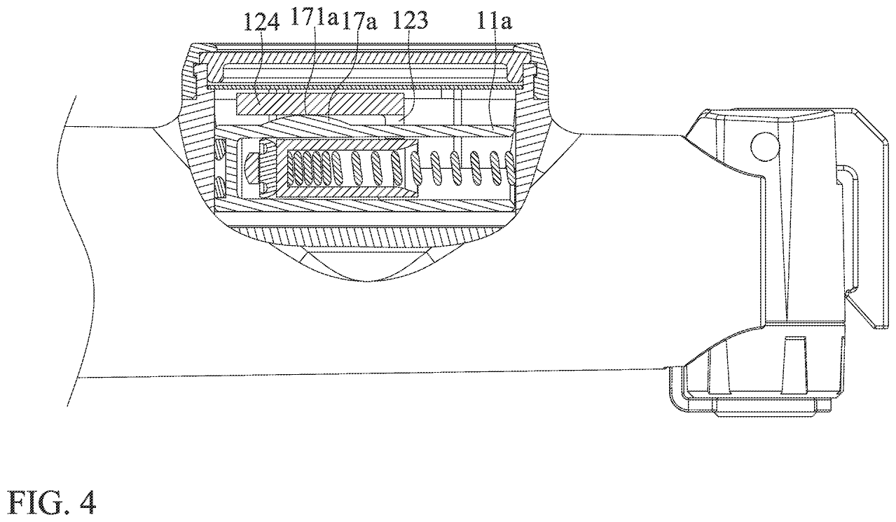

FIG. 4 is a cross sectional views of a pressure gauge of the second embodiment according to the present invention. The second embedment is substantially the same as the first embodiment. The main differences are that the guiding member 17a is integrally formed on the outer periphery of the housing 11a and constantly abuts against the gear rack 124, and the guiding member 17a has an arc face 171a abutting against the gear rack 124 to reduce the friction between the guiding member 17a and the gear rack 124.

Although specific embodiments have been illustrated and described, numerous modifications and variations are still possible without departing from the scope of the invention. The scope of the invention is limited by the accompanying claims.

1. A pressure gauge adapted to be mounted in a containing recess of an air pump comprising:
a housing arranged in the containing recess and permitting the compressed air from the air pump to enter therein;
a driving member movably arranged in the housing and configured to be propelled by the compressed air from the air pump;
a biasing member configured to bias the driving member toward the housing;
a driven member configured to be driven to rotate by the driving member;
a pointer needle connected with the driven member;
a scale plate disposed between the driven member and the pointer needle; and
a guiding member arranged between the housing and the driving member and configured to contact at least one of the housing and the driving member to remain the driving member moving relative to the housing in a straight direction.

2. The pressure gauge as claimed in claim 1, wherein the housing has a sliding hole and an air inlet hole communicating with the sliding hole, wherein the air inlet hole permits the compressed air from the air pump to enter the sliding hole and to propel the driving member, wherein the driving member has a sliding portion movably arranged in the sliding hole, and a driving portion formed on an outer periphery of the sliding portion, wherein the sliding portion is configured to be propelled by the compressed air entering the sliding hole from the air inlet hole to move relative to the sliding hole along a reference axis, and wherein the driving portion connects with the driven member to drive the driven member to rotate.

3. The pressure gauge as claimed in claim 2, wherein the housing further has a notch formed an outer periphery thereof and communicating with the sliding hole, wherein the driving portion has an extending section extended from the outer periphery of the sliding portion, and a gear rack formed from the extending section and extended along the straight direction parallel to the reference axis, wherein the extending section extends through out of the sliding hole via the notch, wherein the gear rack is perpendicular to the extending section and separated from the outer periphery of the sliding portion by a gap formed between the sliding portion and the gear rack, wherein the driven member has an annular teeth portion formed around an outer periphery thereof and meshed with the gear rack, and wherein the gear rack corresponds the sliding portion moving relative to the sliding hole to move along the straight direction parallel to the reference axis to drive the driven member to rotate.

4. The pressure gauge as claimed in claim 3, wherein the guiding member is integrally formed at an end of the gear rack opposite to the extending section and constantly abuts against the outer periphery of the housing.

5. The pressure gauge as claimed in claim 4, wherein the guiding member has an arc face abutting against the outer periphery of the housing.

6. The pressure gauge as claimed in claim 3, wherein the guiding member is integrally formed on the outer periphery of the housing and constantly abuts against the gear rack.

7. The pressure gauge as claimed in claim 6, wherein the guiding member has an arc face abutting against the gear rack.

8. The pressure gauge as claimed in claim 1, wherein the biasing member has a first end elastically abutting against the containing recess, and a second end elastically abutting against the driving member.
